(19) United States
(12) Patent Application Publication
(10) Pub. No.: US 2006/0226260 A1
(43) Pub. Date: Oct. 12, 2006

(54) Apparatus for aerating water

(75) Inventor: Sebastian Jager, Hannover (DE)

Correspondence Address: ROBERT W. BECKER & ASSOCIATES, 707 HIGHWAY 333, SUITE B, TIJERAS, NM, 87059-7507, US

(73) Assignee: Gummi-Jager GmbH, Hannover (DE)

(21) Appl. No.: 11/316,580

(22) Filed: Dec. 22, 2005

(30) Foreign Application Priority Data
Dec. 30, 2004 (DE) 10 2004 063 770.9

(51) Int. Cl. B05B 7/04; B05B 7/06; B05B 1/00; A62C 31/00

(52) U.S. Cl. 239/398; 239/432; 239/596

(57) ABSTRACT

The invention relates to an apparatus for aerating water, with at least one diffuser element through which air is introduced into the water that is to be aerated. The diffuser element is connected with the distribution tube via a tubular connector. The distribution tube conveys the air, which is compressed for the aeration, and in particular has a quadrilateral cross-section.

The invention relates to an apparatus for the aeration of water, with the apparatus having at least one diffuser element, being adapted to be disposed in water, and being adapted to be secured to a distribution tube, whereby compressed air, which can escape into the water via the diffuser element, can be supplied to the apparatus by the distribution tube.

Such apparatus are used, for example, for aerating waste water in so-called activated-sludge ponds. In some applications, distribution tubes are used that have quadrilateral cross-sections. It is an object of the invention to embody the connection between diffuser element and distribution tube in a manner such that it is suitable for quadrilateral distribution tubes.

This object is inventively realized in that the apparatus is provided with a tubular connection, one end of which is inserted into the distribution tube and the other end of which is connected via a connection element with the diffuser element, with the tubular connector extending through a plate that is disposed between distribution tube and diffuser element. In this way, it is possible with simple means to produce the indicated connection, by means of which on the one hand the diffuser element is secured to the distribution tube such that it is protected against tilting, and on the other hand can be supplied with air from the distribution tube.

Pursuant to an advantageous embodiment of the invention, the connection between tubular connector and distribution tube is effected by an elastomeric, in particular rubber, stopper, as described in a similar manner in DE 101 50 180 A1. The stopper can be inserted into a bore in the distribution tube; the tubular connector extends through a bore in the stopper, whereby the fit between tubular connector and stopper is so tight that the stopper is pressed apart, thereby establishing a fixed seating.

On its oppositely disposed sides, the plate can be provided with downwardly bent edges, tabs or the like that rest against the side walls of the distribution tube. This improves/ensures the protection that the diffuser element will not tilt or rotate. This embodiment is particularly advantageous if the plate cannot rest directly upon the upwardly facing surface of the distribution tube, for example because a stopper of the aforementioned type is used that has an edge beading for resting upon the distribution tube.

Pursuant to a further advantageous embodiment of the invention, the tubular connector is embodied in such a way that it extends to the bottom of the distribution tube. This prevents a tipping or tilting of the apparatus. Especially with this embodiment it is advantageous if that portion of the tubular connector that extends into the distribution tube is provided with apertures for the entry of the air.

Further embodiments of the invention will be explained with the aid of the drawing, which illustrates the inventive embodiments and in which:

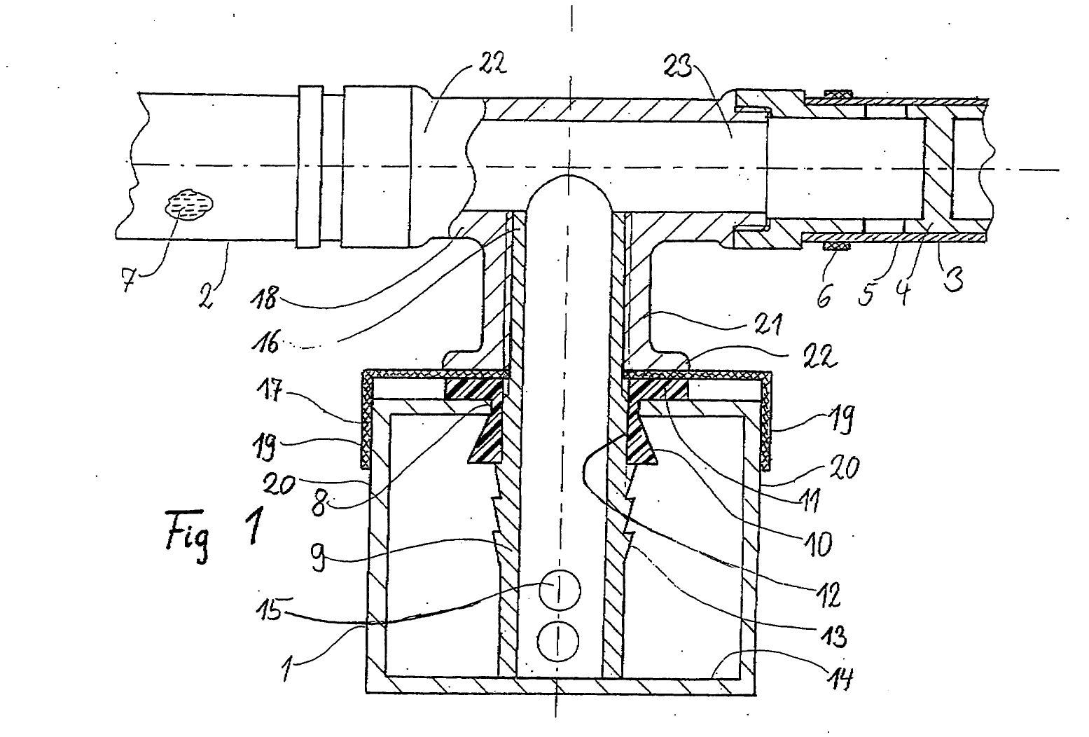

FIG. 1 is a cross-section through an inventive apparatus, whereby the distribution tube is shown in cross-section,

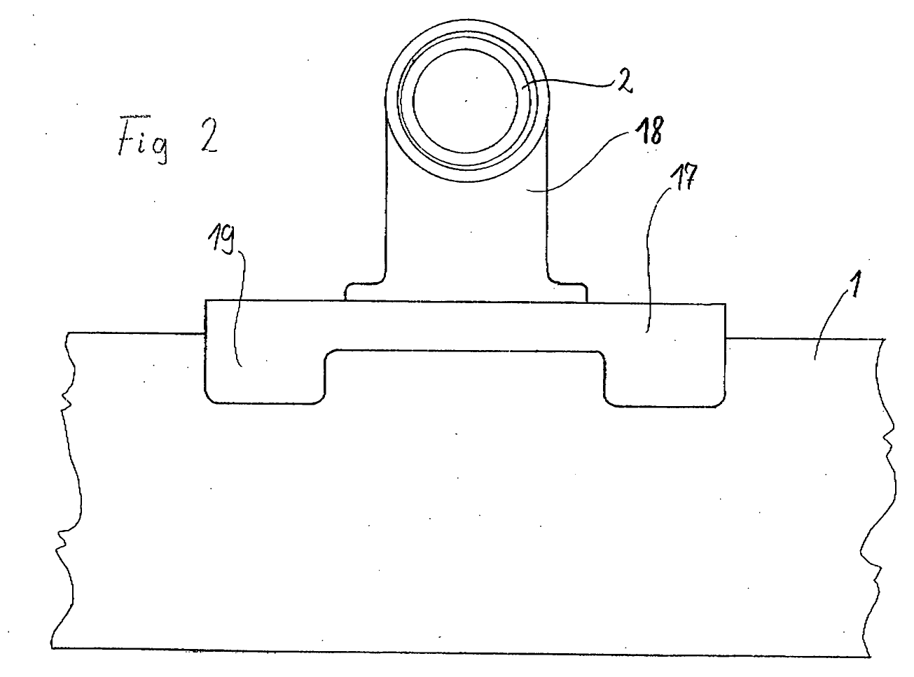

FIG. 2 is a side view of the apparatus of FIG. 1, but rotated by 90°, and

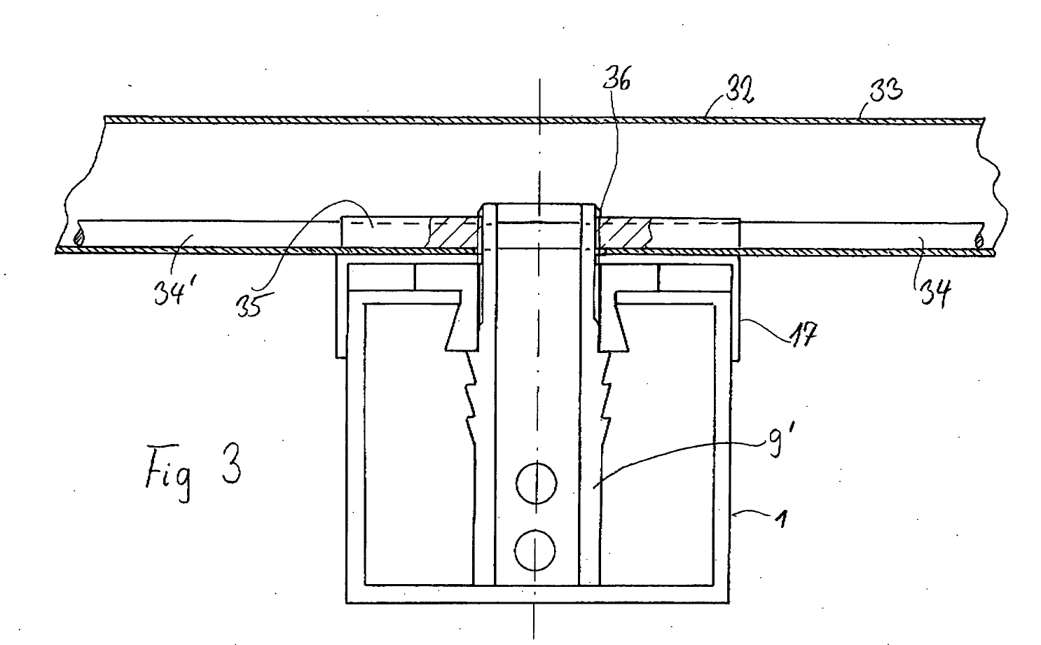

FIG. 3 is an embodiment of the invention that is modified from that of FIG. 1

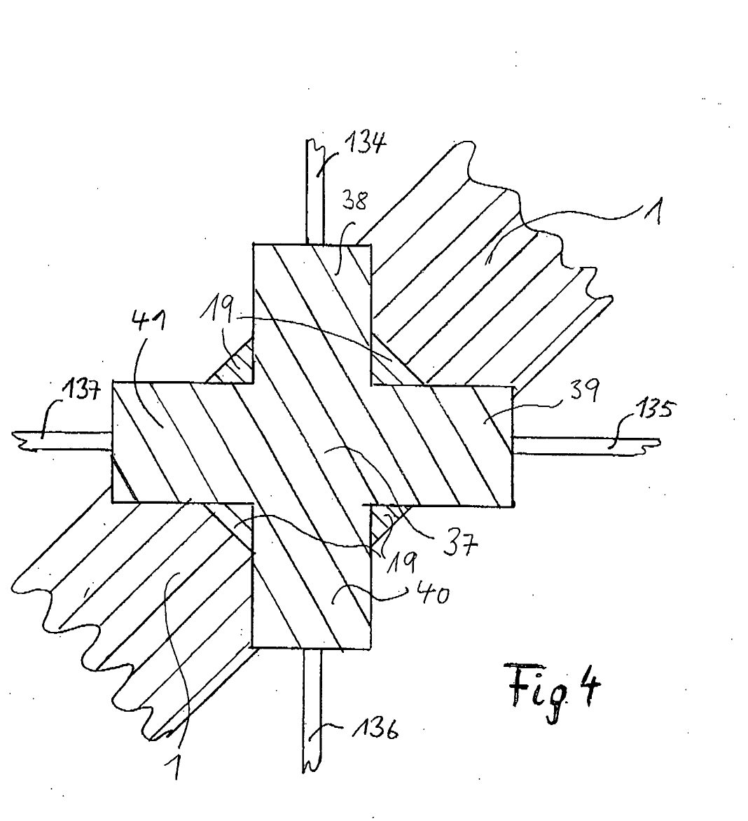

FIG. 4 is a plan view upon a specific embodiment of the invention.

A distribution tube 1 can be disposed in a reservoir or other holding means for liquid that is to be aerated or gasified, for example in a waste water pond of a sewage-treatment plant, preferably in the vicinity of the bottom of the pond. Connected to the distribution tube 1 are aeration or diffuser elements 2 and 3. The diffuser elements 2, 3 are disposed across from one another, and extend transverse to the distribution tube 1. They include support tubes 4 made of a relatively stiff material that are encased with membranes 5 of rubber or a similar material. The membranes 5 can, for example, be secured to the support tubes by clamping rings 6. They are provided with a plurality of fine slits, as indicated by the reference numeral 7 for a small portion thereof. Such diffuser elements are known, and have been described in the literature a number of times, for example in the aforementioned DE 101 50 180 A1. During operation, compressed air is supplied to the diffuser elements 2, 3; the air is conveyed between support tube 4 and membrane 5, and escapes into the surrounding water via the fine slits.

The distribution tube 1 has a quadrilateral cross-section. The important thing is the connection between the distribution tube 1 and the diffuser elements 2 and 3. For this purpose, the distribution tube 1 is provided with a bore 8 at the top through which is guided a tubular connector 9. Seating of the tubular connector 9 in the bore 8 is ensured by a stopper 10. The stopper 10 has a widened rim 11 that rests against the outer wall of the distribution tube 1 when the stopper 10 is installed in the provided position and thus prevents the stopper 10 from being able to be pressed into the distribution tube. The stopper 10 is furthermore provided with a bore 12 that has a conical shape and tapers toward that end that is remote from the widened rim 11 when the stopper 10 is in the initial state. The tubular connector 9 is guided through the bore 12. In so doing, the stopper 10 is widened and in the bore 8 is pressed against the wall of the distribution tube 1, thereby achieving a tight and sealed seating. To additionally ensure the seating in the stopper 10, an appropriate length of the outer surface of the tubular connector 9 is provided with circumferential ribs 13 that have a saw-toothed, barb-like shape.

The tubular connector 9 has such a length that it extends to the bottom 14 of the distribution tube 1. It rests on the bottom 14 to a certain extent, thereby preventing the device from tipping over. Furthermore, it is provided with apertures 15 for an unobstructed entry of air.

On its end 16 that faces away from the distribution tube 1 the tubular connector 9 is provided with an external thread. Screwed on to this external thread are a quadrilateral plate 17 and a T (tube branch) 18.

The plate 17 rests upon the top of the rim 12 of the stopper 10. It is intended to prevent a twisting or rotation of the apparatus. For this purpose, it is provided with edges that are bent over and on which side pieces or tabs 19 are formed that rest against the side walls 20 of the distribution tube 1 (FIG. 1 and FIG. 2).

The branched end 21 of the T 18 has an internal thread by means of which it is screwed onto the external thread of the tubular connector 9. A flange-like edge beading 22 of the T rests upon the plate 17. The diffuser elements 2 and 3 are disposed at the opposing ends 22 and 23 of the T 18. Securement can be effected, for example, by screws.

The tubular connector 9 is thus perpendicular not only to the distribution tube 1 but also to the diffuser elements 2 and 3. By means of the apertures 15, the tubular connector 9, and the T 18, a channel is formed via which the air from the distribution tube 1 can be transported to the diffuser elements 2 and 3.

FIG. 3 shows an embodiment of the invention that is configured for a different type of diffuser elements. In this connection, a diffuser element 32 having a very straightforward construction is involved, such as is described in DE 102 03 780 A1. This diffuser element 32 has a perforated rubber hose 33, in the interior of which is disposed a rod 34, which is thin in comparison to the diameter of the hose, as a reinforcing element. The rod 34 is not interrupted, and is divided outwardly into two sections 34 and 34′ by a connection element 35. The rod 34 can be secured to the connection element i.e. can be secured against shifting in the longitudinal direction, by screws, welding, or in some other suitable fashion.

An appropriate securement is recommended if the rod 34 has a two-part configuration, in other words, does not pass through the connection element.

In comparison to the embodiment of FIG. 1, the tubular connector 9′ is shorter. Only the connection with the diffuser element 32 has a different configuration than in the embodiment of FIGS. 1 and 2, and it is only this different configuration that will here be described.

The connection element 35 has a bore 36 having a thread into which the tubular connector 9′ is screwed. The hose 32 is slitted in the adjoining region, and the tubular connector 9′ is guided through the slit. The slitted region is sealed off when the hose 33 is clamped between the connection element 35 and the plate 17 by a tightening on the tubular connector 9′.

FIG. 4 is a plan view onto a specific embodiment of the invention. The rubber hose that encases the rods 134, 135, 136 and 137 is not illustrated here. With this modified embodiment, a total of four rods 134 to 137 are used; they are connected in a star-shaped manner with the connection element 37. In contrast to the embodiment of FIG. 1 having the T 18, the connection element 37 is not embodied as a T having the two ends 22 and 23, but rather is provided with four air supply channels 38, 39, 40 and 41 to each of which is secured a rubber hose, with the respective securement being effected in the manner described in conjunction with FIG. 1. By means of such a star-shaped arrangement, it is possible to achieve a quasi laminar, in particular plate-shaped, aeration.

It is to be understood that any number of connected air supply channels can be provided, in particular even an odd number.

1-8. (canceled)

9. An apparatus for aerating water, comprising:
at least one diffuser element that is adapted to be disposed in water and is also adapted to be secured to a distribution tube for receiving compressed air therefrom, wherein such air is adapted to escape into the water from said at least one diffuser element;
a tubular connector having a first end that is adapted to be inserted into the distribution tube and a second end that is connected via a connection element with said at least one diffuser element; and
a plate that is disposed between said connection element and the distribution tube, wherein said tubular connector extends through said plate.

10. An apparatus according to claim 9, wherein an elastomeric stopper is inserted into a bore in the distribution tube, and wherein said tubular connector extends through a bore in said stopper.

11. An apparatus according to claim 10, wherein an outer surface of that portion of said tubular connector that is inserted into said elastomeric stopper is provided with projections.

12. An apparatus according to claim 11, wherein said projections have a saw-toothed profile.

13. An apparatus according to claim 9, wherein an end of said tubular connector that faces away from the distribution tube is provided with an external thread that is adapted to be screwed into a bore in said connection element.

14. An apparatus according to claim 9, wherein said connection element is a branched tube through which air that is to be supplied to said at least one diffuser element is adapted to be conveyed, wherein said tubular connector is inserted into one branch of said branched tube, and wherein the remaining branches of said branched tube are connected with said at least one diffuser element.

15. An apparatus according to claim 14, wherein said branched tube is a T.

16. An apparatus according to claim 9, wherein that end of said tubular connector that is adapted to be inserted into the distribution tube is adapted to contact the bottom of the distribution tube.

17. An apparatus according to claim 9, wherein that end of said tubular connector that is adapted to be inserted into the distribution tube is provided with apertures for a passage of air therethrough.

18. An apparatus according to claim 9, wherein said plate is provided with bent-over edges or tabs that are adapted to rest against side walls of the distribution tube.
